(19) United States
(12) Patent Application Publication
(10) Pub. No.: US 2005/0144392 A1
(43) Pub. Date: Jun. 30, 2005

(54) Fixed timeframe cache tag array arbitration mechanism for invalidations

(76) Inventor: George Z. Chrysos, Milford, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/749,435

(22) Filed: Dec. 30, 2003

(51) Int. Cl. G06F 12/00

(52) U.S. Cl. 711/133; 711/145

(57) ABSTRACT

A mechanism which allows invalidations several attempts to read the tag array and perform a invalidation. If in a given cycle, an invalidation request conflicts with a fill request, the invalidation request is piped and tried again in the next cycle. After several attempts, the invalidation will give up on trying to read the tag array and just perform invalidation on every block in the indexed set.

### BACKGROUND INFORMATION

To maintain memory coherence, a cache must process invalidation requests to blocks that are shared (S in MESI). This requires access to a cache tag array to determine whether the targeted block is in the cache. However, other operations that require tag array access can also be occurring simultaneously (fills, reads, or writes). Since providing dedicated ports into the tag array for all possible users of the tag array in a given cycle is expensive (generally area increases as the number of ports squared, and power consumption increases linearly with area), arbitration amongst multiple user for fewer ports is necessary.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the inventions.

FIG. 1 is a flowchart for a fixed timeframe cache tag array arbitration mechanism for invalidations.

### DETAILED DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

Each processor core may have its own private cache. The cache has a tag array that contains information about which blocks are in the cache. Each invalidate request has an address of the block associated with it and the address consists of an index to the tag array. The tag array may be accessed for multiple reasons. One reason may be during a invalidate request, the processor searches its cache to determine if it has the requested block. If the cache has the block, it has to invalidate the requested block. Now new loads coming into an execution pipeline will not be able to hit the cache.

A second reason may be during a fill request where the tag array is updated. When a fill request is sent, a block is requested, the block is obtained, the block is filled into the cache and then the tag is written to. A fill and invalidate request may happen simultaneously. They can also happen every cycle. The following mechanism focuses on conflicts between fills and invalidations happening simultaneously, but, the mechanism described can be generally applied to invalidations conflicting with any other operation type.

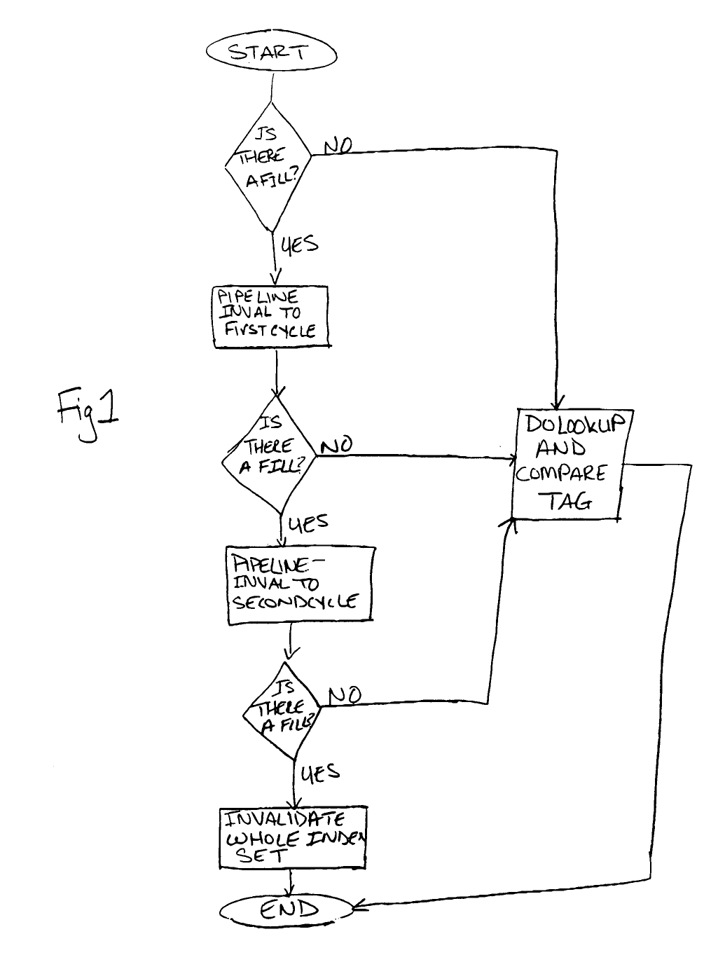

FIG. 1 is a flowchart for a fixed timeframe cache tag array arbitration mechanism for invalidations. Initially, a invalidate request is sent into a pipeline. This means that a targeted cache is being sent the address of the block in question. In step 100, an orchestrating agent determines if any fills are also coming into the pipeline. If no fills are coming into the pipeline, then the targeted cache performs a tag array lookup and compares the addresses found in the indexed set to the sent address. If the tags match, the targeted cache clears the valid bit in the tag array to prevent subsequent hits on that block in the cache (step 110). If there is a fill, then there is a collision of a fill and invalidate occurring in the same cycle. In this case, invalidate request is pipelined to the first cycle (step 120). The orchestrating agent again determines if there is a fill in step 130. If no fill is occurring, then step 110 is repeated, otherwise, the invalidate request is pipelined to the second cycle (step 140). Again it is determined if a fill has occurred in step 150. If not, step 110 is repeated. Otherwise, the whole index set is now invalidated in step 160. The index bits of the invalidated block can simply clear the valid bits of every block in the indexed set (guaranteeing that if the block was resident in the cache, it is now invalid).

This above described mechanism gives invalidations several “tries” to read the tag array and perform a precise invalidation (the tag matches the invalidation block address). If in a given cycle, an invalidation request conflicts with a fill request or even an older invalidation, the invalidation request is piped and tried again in the next cycle. After some number of tries, the invalidation will give up on trying to read the tag array and just perform a invalidation on every block in the set. The number of tries can be arbitrarily lengthened to provide less probability of the full set invalidation, with the provision that the time that the core guarantees invalidation of a block will then extend, and may delay granting ownership of the block to another CPU.

By allowing three tries to invalidate, the present mechanism builds more tolerance into a cache coherent computer system. It allows the invalidation three chances to actually do a real lookup into a port and guarantee that invalidation has been completed. After those three chances expire, the whole index set is invalidated.

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

1. A method for invalidations comprising:
requesting an invalidation operation;
requesting a fill operation;
piping the invalidation request one or more cycles upon receiving a fill request; and
performing invalidations on every block of an indexed set.

2. The method of claim 1 wherein the step of requesting an invalidation operation comprises the step of sending an address of the block.

3. The method of claim 2 wherein if no fill request is received, the method further comprising the steps of:
performing a tag array lookup; and
comparing addresses found in the index set to the sent address.

4. The method of claim 3 further comprising the step of clearing valid bit in the tag array if the addresses match.

5. The method of claim 2 wherein if a fill request is received, the method further comprising the step of piping the step of requesting invalidation operation to the next cycle.

6. The method of claim 5 wherein the step of piping one or more cycles occurs for three cycles.

7. A method for invalidation comprising:
requesting an invalidation operation;
requesting an operation;
piping the invalidation request one or more cycles upon receiving an operation request; and
performing invalidations on every block of an indexed set.

8. The method of claim 7 wherein the step of requesting an invalidation operation comprises the step of sending an address of the block.

9. The method of claim 8 wherein if no operation request is received, the method further comprising the steps of:
performing a tag array lookup; and
comparing addresses found in the index set to the sent address.

10. The method of claim 9 further comprising the step of clearing valid bit in the tag array if the addresses match.

11. The method of claim 8 wherein if an operation request is received, the method further comprising the step of piping the step of requesting invalidation operation to the next cycle.

12. The method of claim 11 wherein the step of piping one or more cycles occurs for three cycles.
